(19) United States
(12) Patent Application Publication
(10) Pub. No.: US 2002/0009173 A1
(43) Pub. Date: Jan. 24, 2002

(54) Method to control reactions involving isotopic fuel within a material using orthogonal electric-fields

(76) Inventor: Mitchell R. Swartz, Weston, MA (US)

Correspondence Address: Mitchell R. Swartz, ScD, MD, EE, 16 Pembroke Road, Weston, MA, 02493, US

(21) Appl. No.: 09/748,691

(22) Filed: Dec. 26, 2000

Related U.S. Application Data
(62) Division of application No. 07/760,970, filed on Sep. 17, 1991.

(51) Int. Cl. G21J 1/00; G21B 1/00

(52) U.S. Cl. 376/100

(57) ABSTRACT

The present invention relates to methods and systems to control reactions involving isotopic fuels within a material, such as hydrogen within palladium.

The method and apparatus uses at least two non-parallel electric-fields to control the loading into the material and redistribution of the isotopic fuel within the material.

The present invention relates to methods and systems to control reactions involving isotopic fuels within a material, such as hydrogen within palladium.

The method and apparatus uses at least two non-parallel electric-fields to control the loading into the material and redistribution of the isotopic fuel within the material.

By way of background and to place reasonable limits on the size of this disclosure, the following publications are noted:

### U.S. PATENT DOCUMENTS

Ser. No. 07/339,976 filing date Apr. 18, 1989 Swartz, M. R., “Systems to Increase the Efficiency, Control, Safety and Energy Utilization of Electrochemically Induced Fusion Reactions”.

Ser. No. 07/371,937 Jun. 27, 1989 Swartz, M. R., “Systems to Monitor and Accelerate Electrochemically Induced Fusion Reactions”.

### FOREIGN PATENT DOCUMENTS

Other Publications

The present invention relates to electrochemical reactions in or about metals, such as palladium which has been electrochemically loaded with deuterium, but it has relevance as well, to hydrogen storage, fuel cells, nuclear fusion, and other reactions in pressure-loaded metals such as titanium or palladium filled with deuterium, and to the broader field of metallurgy and engineering in or about metals, including Groups IVb, Vb, and some rare earths.

The following journal articles and papers and may be used by way of background material and to supplement this specification:

C. A. HAMPEL, Rare Metals Handbook, Reinhold Publishing Corp, (1954).

M. HANSEN, Constitution of Binary Alloys, McGraw-Hill Book Co., Inc (1958).

C. J. SMITHELLS, Metals Reference Book, Butterworths Scientific, (1949).

H. H. UHLIG, Corrosion and Corrosion Control, John Wiley & Sons, Inc., (1971).

Controlled reactions in loaded metals offers the possibility of more efficient and inexpensive energy.

However, there are problems. First, the desired reactions are not well controlled. The proven difficulties of loading, the slow initiation of the desired reactions, and the difficulty in controlling the reactions has limited research and development of this technology.

Second, prior to the desired reactions, the cathodes must be filled with deuterons to concentrations which require significant times of charging.

Third, palladium, the preferred metal of these reactions, is expensive.

Fourth, the rates of the desired reactions are very low in the steady state.

Accordingly, it is a principal object of the present invention to provide a novel method and system to control and enhance desired reactions.

Another object of the present invention is to minimize the required quantity of expensive palladium used.

Another object of the present invention is to maximize the local quantity of the hydrogen within the palladium.

Another object of the present invention is to provide a novel method to improve the removal of the product generated.

These and still further objects are addressed hereinafter.

The foregoing objects are achieved in a method which includes in combination supplying an isotopic fuel to said material, loading said isotopic fuel into said material by an applied electric field, and applying the second applied electric field to redistribute said isotopic fuel which allows control of the distribution of the loaded isotopic fuel within the material.

The invention is hereafter described with reference to the accompanying drawings in which:

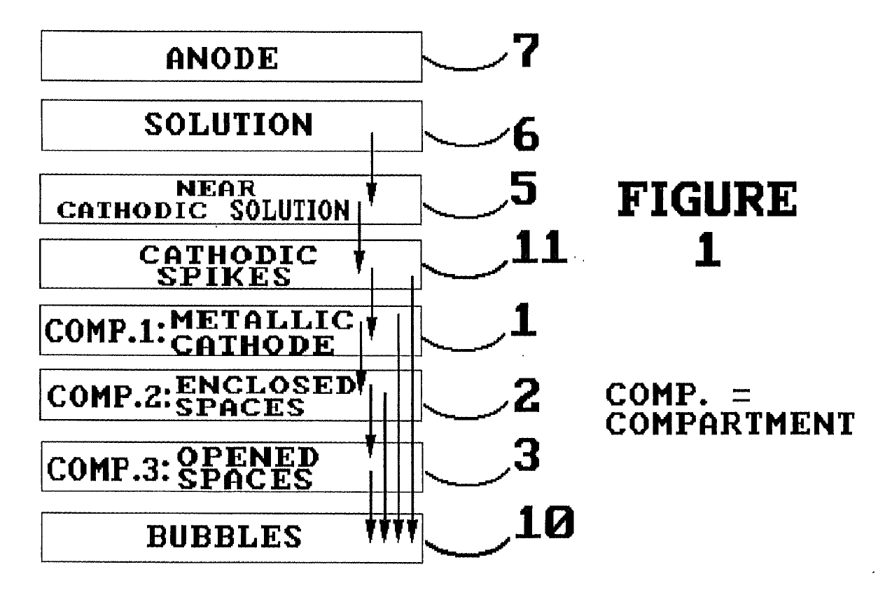

FIG. 1 symbolically shows the compartments used to analyze an electrochemical reactor. The cathode is dissected into four region, and three compartments within the metal itself. The flow of deuterons is shown by arrows.

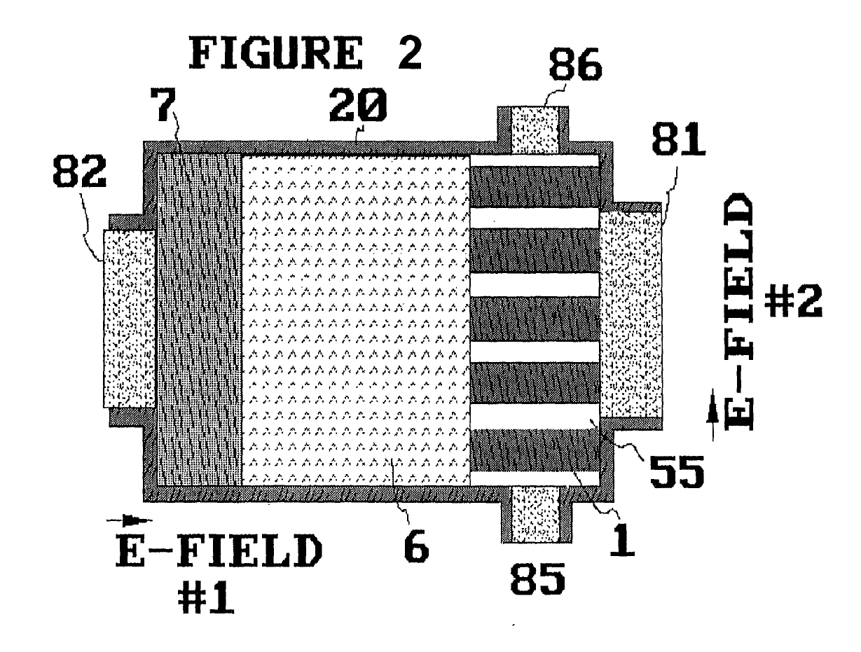

FIG. 2 is a crossectional drawing of a lamellar CAM reactor. This device has two orthogonal applied electric fields. The second applied electric field intensity is delivered after full charging. Between these slabs of the cathode alternate deuteron-impermeable barriers.

FIG. 3 shows three lamellar CAM reactors. Each device is equipped with orthogonal applied electric fields. Said apparatus has a thermal bus connected to the heat pipes which are held within a mechanical connecting system.

Turning now to the figures: FIG. 1 symbolically shows the compartments used to analyze an electrochemical reactor. FIG. 1 gives organization to the different parts of a simple reactor referred to in this disclosure. It is not meant to be physically realistic with respect to size. The cathode is dissected into four regions. Three compartments are shown within the metal itself. The flow of deuterons is shown by arrows. The label 1 represents the metallic cathode, usually palladium in the preferred configuration. The labels 2 and 3 represents compartments 2, and 3 respectively, which are discussed in detail below

The label 7 represents the anode which in the preferred embodiment is composed of palladium. The label 6 represents the solution consisting in the preferred embodiment of a gel containing antidesiccant, in combination with LiOD, palladium salts, and heavy water (D20).

The power supply and control unit consists of a current source and reactor control device as described in Swartz (1989), and are not shown in the figure. The application of said power source creates an applied electric field intensity which produces cation flow towards the cathode. There results in the near cathode solution (labelled as 5 in FIG. 1) a buildup of deuterons, and a low dielectric constant (gas bubble) layer. The bubbles are labelled as number 10 in FIG. 1. There may be spikes or on the cathode (labelled as 11 in FIG. 1).

FIG. 2 is a crossectional drawing of a lamellar CAM reactor. This device has two orthogonal applied electric fields. The first (labelled E-field number 1 in the the figure) is that which is applied to charge the palladium with deuterons. The second applied electric field intensity is delivered after full charging has been achieved. In the figure the anode and cathode are labelled as 7 and 1. The electrolyte solution or gel is labelled as 6. The connections for the first electric field are labelled as 81 and 82. The connections for the second electric field are labelled as 85 and 86. The mechanical casing is labelled 20. The deuteron impermeable barrier is comb-shaped in this preferred configuration, and is labelled 55 in FIG. 13.

The cathode in this preferred configuration is divided into parallel slabs. Between these slabs alternate deuteron-impermeable barriers. Application of the second electric field causes the deuterons already loaded in the cathode to redistribute, but the deuteron-impermeable barrier(s) act to enhance the desired reactions.

Turning to FIG. 3 which shows three lamellar CAM reactors. Each device is equipped with orthogonal applied electric fields. The second applied electric field intensity is delivered after full charging. Each reactor is labelled as 90 in FIG. 3, but similar to what is shown in FIG. 2. These devices each contain a cathodes (labelled 1), intradevice gel containing lithium and palladium deuteroxide (labelled 6), and anode (labelled 7).

These CAM devices are inserted, similar to a fuse onto a holding board, held in place by clips (labelled 101). The three CAM device are shown connected to a microprocessor control system (labelled 110). Said apparatus has an electrical bus to connect the anodes (labelled 105) which are connected to the anodic connectors (labelled 82). Said apparatus has an electrical bus to connect the cathodes (labelled 106 and 107) which are connected to the cathodic connectors (not labelled in the figure). The cathodic system buses (106 and 107) are electrically shorted together during the deuterium charging.

Said apparatus has a thermal bus (labelled 107) connected to the heat pipes (labelled 70) which are held in a mechanical connecting system (labelled 20).

The result is the piling up of deuterium at the deuteron-impermeable barriers (labeled 55 in FIG. 3). The heat energy is directed out via the the heat pipes (70) and the thermal bus (107). The damage or rundown of one CAM unit is thus easily corrected by exchange or replacement of the defective unit with a functional one.

The purpose of the receptor apparatus is first to integrate the three (or more) CAM reactor units. The three cathodic connectors are connected to the control apparatus. However, after loading the cathodes, the cathodic buses (106 and 107) are separated and a second electric potential is supplied between these two buses. The result is the second applied electric field which is shown in FIG. 2, but not in FIG. 3.

Modification of the invention herein disclosed will occur to persons skilled in the art and all such modifications are deemed to be within the scope of the invention as defined by the appended claims.

What is claimed is:

1. In a process for producing a product using a material loaded with an isotopic fuel, a method to control the production of said product which includes in combination:
supplying said isotopic fuel to said material,
loading said isotopic fuel into said material, and
applying in combination two non-parallel applied electric fields.

2. In a method of claim 1 wherein said two applied electric fields are orthogonal.

3. In a method of claim 1 wherein said two applied electric fields are sequentially applied.

4. In a method of claim 1 wherein said electric fields are applied in the sequence, first to load said metal with isotopic fuel, and second to effect redistribution of the fuel within said loaded metal.

5. In a method as in claim 1, where the isotopic fuel is a member of the group consisting of an isotope of hydrogen, boron, lithium, or potassium.

6. In a method as in claim 1, where the material is a member of the group consisting of palladium, titanium, or nickel or their alloys.

7. In a method as in claim 6, where the material is an electrochemical cathode.

8. In a method as in claim 1, where the additional step is taken of applying a magnetic field intensity through said material.

9. In a method as in claim 8, where the applied magnetic field intensity is inhomogeneous.

10. In a process for producing a product using a material by a reaction, a method to control the production of said product which includes in combination:
supplying an isotopic fuel to said material,
loading said isotopic fuel into said material by an applied electric field, and
applying the second applied electric field to redistribute said isotopic fuel.

11. In a method as in claim 10, where the isotopic fuel is a member of the group consisting of an isotope of hydrogen, boron, lithium, or potassium.

12. In a method as in claim 10, where the material is a member of the group consisting of palladium, titanium, or nickel.

13. In a method as in claim 10, where the additional step is taken of creating a gradient in the intensity of magnetic field through said material.

14. In a method as in claim 10, where the material is an electrochemical cathode.

15. An apparatus to produce a product using a material loaded with an isotopic fuel, which includes in combination:
means to supply said isotopic fuel to said material,
means to load said isotopic fuel into said material by an applied electric field, and
means to provide a second applied electric field to redistribute said isotopic fuel.

16. An apparatus as in claim 15, where the isotopic fuel is a member of the group consisting of an isotope of hydrogen, boron, lithium, or potassium.

17. An apparatus as in claim 15, where the material is a member of the group consisting of palladium, titanium, or nickel.

18. An apparatus as in claim 15, where at least one reaction at the material is electrochemical.

19. An apparatus as in claim 18, where the material is electrochemically polarized as the cathode.

20. An apparatus as in claim 15, where means are provided to concentrate, cluster, compact, or collect the isotopic fuel within a portion of the material.
